(19) United States
(12) Patent Application Publication
(10) Pub. No.: US 2018/0137165 A1
(43) Pub. Date: May 17, 2018

(54) DATA CONSISTENCY IN A DISTRIBUTED ENVIRONMENT

(71) Applicant: International Business Machines Corporation, Armonk, NY (US)

(72) Inventors: RAVI KUMAR R. KANAMATAREDDY, Hyderabad (IN); AKILA VASUDEVAN, Bangalore (IN)

(21) Appl. No.: 15/888,367

(22) Filed: Feb. 5, 2018

Related U.S. Application Data
(63) Continuation of application No. 15/279,589, filed on Sep. 29, 2016.

(51) Int. Cl. G06F 17/30; G06F 21/62

(52) U.S. Cl. CPC G06F 17/30371; G06F 21/6218; G06F 17/30339

(57) ABSTRACT

In an embodiment of the present invention, a request for data in a database is received from a client. A data state service is accessed to determine availability of the data. Responsive to determining, via the data state service, that the data is available, the client is permitted to access the data.

### BACKGROUND OF THE INVENTION

The present invention relates generally to the field of data processing, and more particularly to real-time data processing.

A database is an organized collection of data in the form of schemes, tables, and other objects. Access to the data of a database may be provided by a database management system consisting of an integrated set of computer software that allows users to interact with one or more databases and provides access to all of the data contained in the databases. A database management system is generally designed to allow operations such as defining, creating, querying, updating data in databases.

### SUMMARY

Embodiments of the present invention include a method, computer program product, and system for providing data consistency in a virtual data processing environment. In one embodiment, a request for data in a database is received from a client. Further, it is determined that the client has permission to access the database previous to accessing the data state service, wherein determining that the client has permission to access the database comprises accessing directory service entry information, it is determined that the client has permission to access a data type and a table type of the data previous to accessing the data state service, and it is determined that a data state service is available previous to accessing the data state service. A data state service is accessed to determine availability of the data. Responsive to determining, via the data state service, that the data is available, the client is permitted to access the data, and responsive to determining, via the data state service, that the data is not available, terminating the request.

### BRIEF DESCRIPTION OF THE DRAWINGS

FIG. 1 is a functional block diagram of a distributed data processing environment, in accordance with an embodiment of the present invention;

FIG. 2 is a workflow of operational steps of one example of a method for providing data consistency in a data processing environment, in accordance with an embodiment of the present invention;

FIG. 3 is a workflow of operational steps of one example of a method for providing data consistency in a data processing environment, in accordance with an embodiment of the present invention; and

FIG. 4 is a block diagram of components of one embodiment of the server device and computing device of FIG. 1, in accordance with an embodiment of the present invention.

### DETAILED DESCRIPTION

Embodiments of the present invention recognize that performance-oriented database management platforms have many inherent problems including schedule-based data inconsistency. Embodiments of the present invention recognize that certain inaccuracies in data processing cannot be verified in instances where the data format is legal. Embodiments of the present invention further recognize that businesses require data to be made available as quickly as transaction processing occurs.

Embodiments of the present invention provide techniques for providing data consistency in a data processing environment (including a virtual environment). The techniques are flexible and accommodate various data governance requirements of databases.

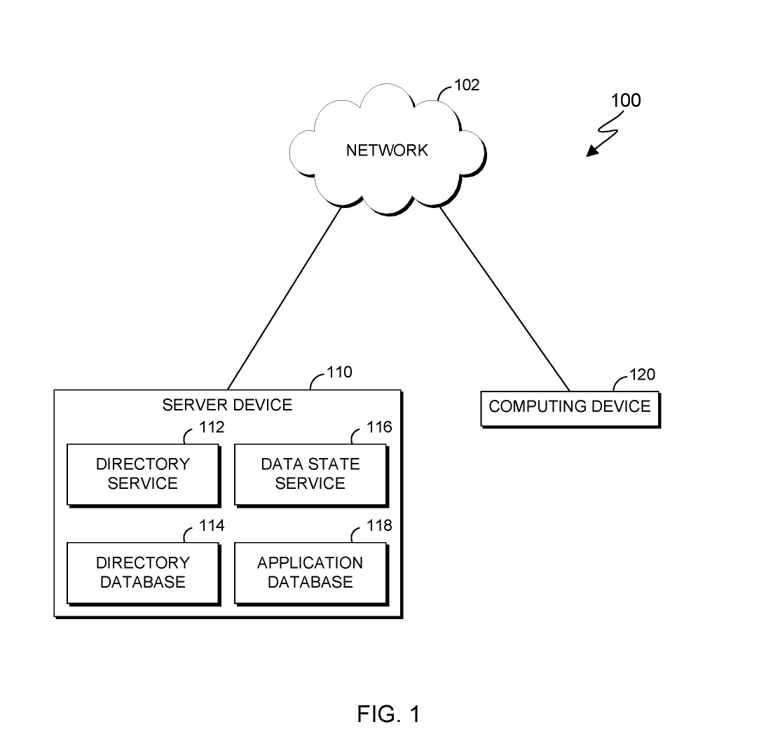

The present invention will now be described in detail with reference to the Figures. FIG. 1 is a functional block diagram of a computing environment, generally designated 100, in accordance with an embodiment of the present invention. FIG. 1 provides only an illustration of one implementation and does not imply any limitations with regard to the environments in which different embodiments may be implemented. Those skilled in the art may make many modifications to the depicted environment without departing from the scope of the invention as recited by the claims.

In the illustrated embodiment, distributed data processing environment 100 includes server device 110 and computing device 120. Server device 110 and computing device 120 are interconnected through network 102. In an embodiment, distributed data processing environment 100 may additionally include any other computing device connected to network 102.

In an embodiment, network 102 may generally be any combination of connections and protocols that supports communications between server device 110 and any other computing device connected to network 102. In example embodiments, network 102 may be a local area network (LAN), a telecommunications network, a wide area network (WAN), such as the Internet, or any combination thereof. In an embodiment, network 102 may include wired, wireless, or fiber optic connections.

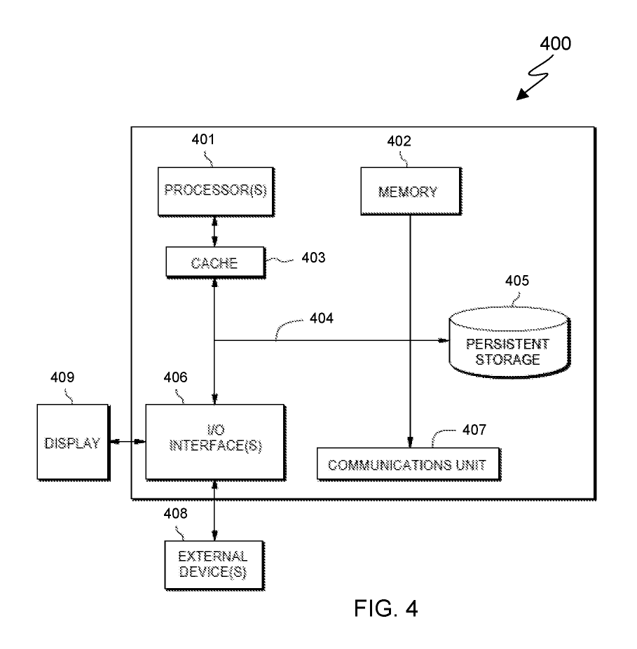

In an embodiment, server device 110 may generally be any electronic device or combination of electronic devices capable of executing computer readable program instructions. In example embodiments, server device 110 may be a personal computer, workstation, mobile phone, or personal digital assistant. In an embodiment, server device 110 may be a computer system utilizing clustered computers and components, such as database server devices or application server devices, that act as a single pool of seamless resources when accessed by elements of distributed data processing environment 100, such as in a cloud computing environment. Server device 110 may include components as depicted and described with respect to computer 400 (see FIG. 4), in accordance with embodiments of the present invention. In an embodiment, computing device 120 may be substantially similar to server device 110 and may include substantially similar components.

In an embodiment, server device 110 includes directory service 112, directory database 114, data state service 116, and application database 118. In an alternative embodiment, directory service 112 or data state service 116 may be located on any other computing device connected to network 102, and directory service 112 or data state service 116 may communicate with server device 110 through network 102. In another alternative embodiment, directory database 114 or application database 118 may be located on any other computing device connected to network 102, and directory database 114 or application database 118 may communicate with server device 110 through network 102.

In an embodiment, directory service 112, in general, is any protocol, computer program, application, subprogram of a larger computer program, or a combination thereof that provides authentication functions for accessing and managing data stored in application database 118, in accordance with embodiments of the present invention. As an example, directory service 112 may be an authentication system or protocol such as Lightweight Directory Access Protocol (LDAP), Active Directory (AD), Remote Authentication Dial-In User Service (RADIUS), Diameter, Kerberos, or Security Assertion Markup Language (SAML). In an embodiment, directory service 112 carries out authentication functions by referencing and managing data stored in directory database 114. In an embodiment, functions for authentication include receiving a data request for application database 118 from a user computing device, or client, verifying a password with a user account, and verifying the scope of the data request against the scope of data privileges associated with the user account. In an embodiment, functions for managing data include functions to add, delete, modify, rearrange, retrieve, and otherwise manipulate data entries stored in directory database 114.

In an embodiment, directory database 114 contains data entries on which operations may be performed by directory service 112. In an embodiment, data entries in directory database 114 include user account information, password information associated with each user account, and privilege information relating to the scope of data that is permitted to be accessed or manipulated by each user account. In an embodiment, directory database 114 may be designed to support atomic, transactional processing of data (e.g., an online transaction processing (OLTP) database). In an embodiment, data in directory database 114 is organized as one or more tables. Tables in directory database 114 may or may not include partitions. A partition is a portion of a table that is treated as an independent unit by directory service 112 during operations on data of the partition.

In an embodiment, directory database 114 may be implemented using any non-volatile storage media known in the art. For example, directory database 114 may be implemented with a tape library, optical library, one or more independent hard disk drives, or multiple hard disk drives in a redundant array of independent disks (RAID). In an embodiment, directory database 114 may be implemented using any suitable storage architecture known in the art. For example, directory database 114 may be implemented with a relational database, an object-oriented database, or an object-relational database.

In an embodiment, application database 118 contains data on which operations may be performed by data state service 116. In an embodiment, each data entry in application database 118 is associated with profile information, which may include the date and time at which a data entry was added to application database 114 or the date and time at which the data entry was last updated, if more recent. In an embodiment, directory database 114 may be designed to support atomic, transactional processing of data (e.g., an online transaction processing (OLTP) database). In an embodiment, data in application database 118 is organized as one or more tables. In an embodiment, application database 118 contains separate indications of the state of availability of the data stored therein. Tables in directory database 114 may or may not include partitions. A partition is a portion of a table that is treated as an independent unit by data state service 116 during operations on data of the partition.

In an embodiment, application database 118 may be implemented using any non-volatile storage media known in the art. For example, application database 118 may be implemented with a tape library, optical library, one or more independent hard disk drives, or multiple hard disk drives in a redundant array of independent disks (RAID). In an embodiment, application database 118 may be implemented using any suitable storage architecture known in the art. For example, application database 118 may be implemented with a relational database, an object-oriented database, or an object-relational database.

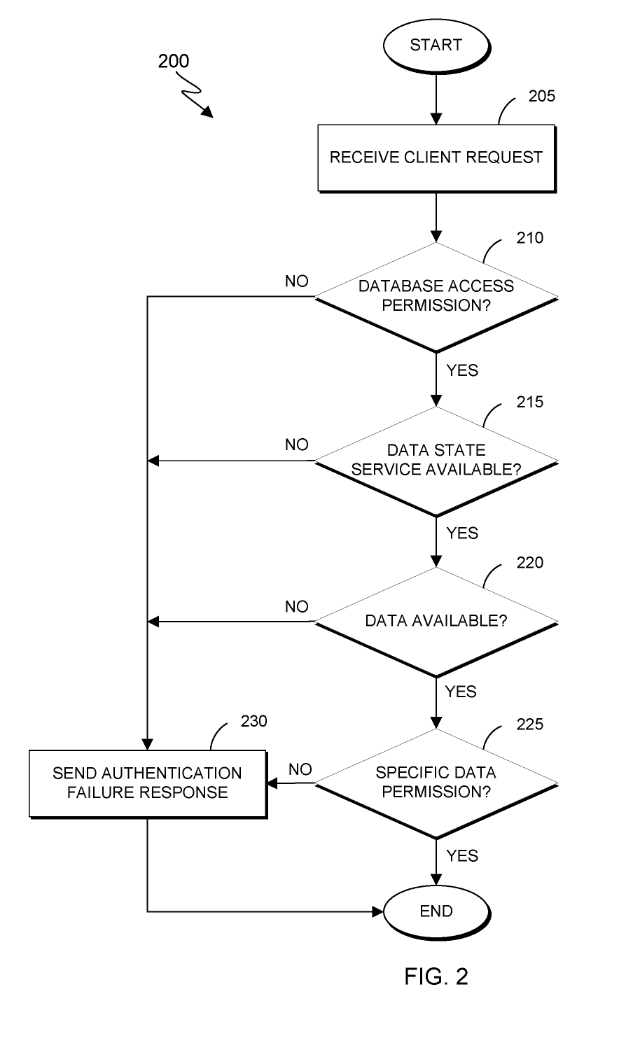

FIG. 2 is a workflow of operational steps of one example of a method for providing data consistency in a data processing environment. In the illustrated embodiment, the steps of workflow 200 are performed by directory service 112. In an alternative embodiment, the steps of workflow may be performed by any other computer program, or programs, while working with directory service 112. In an embodiment, directory service 112 begins performing the steps of workflow 200 in response to receiving an indication to begin providing data consistency in a virtual data processing environment. For example, a user, through the user interface of directory service 112, may provide the indication.

Directory service 112 receives a client request (step 205). In other words, directory service 112 receives a request to access data in application database 118 from computing device 120, or the client.

Directory service 112 determines if the client has database access permission (decision block 210). In other words, directory service 112 determines if the client has permission to access application database 118. In an embodiment, directory service 112 determines if the client has provided a valid user account and password. In an embodiment, directory service 112 receives a user account and password from the client, and directory service 112 accesses the data entries in directory database 114 to determine if the user account and password provided by the client are consistent with the user account and associated password in directory database 114.

If directory service 112 determines that the client does not have database access permission (decision block 210, no branch), then directory service 112 sends an authentication failure response (step 230). In other words, directory service 112 sends a response to the client indicating that the request can not be authenticated, and directory service 112 terminates the request. For example, directory service 112 may send a response message indicating that the user account does not exist. As another example, directory service 112 may send a response indicating that the password is not consistent with the password associated with the user account.

If directory service 112 determines that the client has database access permission (decision block 210, yes branch), then directory service 112 determines if data state service 116 is available (decision block 215). In other words, directory service 112 determines if data state service 116 is configured and available for communication with directory service 112.

If directory service 112 determines that data state service 116 is not available (decision block 215, no branch), then directory service 112 sends an authentication failure response (step 230). In other words, directory service 112 sends a response to the client indicating that the request can not be authenticated, and directory service 112 terminates the request. For example, directory service 112 may send a response message indicating that there is a sync error between the directory service and the data state service.

If directory service 112 determines that data state service 116 is available (decision block 215, yes branch), then directory service 112 determines if the data is available (decision block 220). In other words, directory service 112 determines if the requested data in application database 118 is available for access or manipulation by the client. In an embodiment, to determine if the requested data is available, directory service 112 accesses data state service 116, and data state service 116 determines the state of the data requested by the client, i.e., data state service 116 determines if the requested data is available for access by the client (see workflow 300).

If directory service 112 determines that the data is not available (decision block 220, no branch), then directory service 112 sends an authentication failure response (step 230). In other words, directory service 112 sends a response to the client indicating that the request can not be authenticated, and directory service 112 terminates the request. For example, directory service 112 may send a response message indicating that the requested data does not exist. In an embodiment, in an instance where the range of the requested data includes data determined to be available as well as data determined to be unavailable, directory service 112 sends a response to the client indicating the range of the requested data that is available, and recommending a reconfiguration of the request accordingly.

If directory service 112 determines that the data state is available (decision block 220, yes branch), then directory service 112 determines if the client has specific data permission to access the requested data (decision block 225). In other words, directory service 112 determines if the scope of the data request from the client is within a permitted scope. In an embodiment, directory service 112 accesses the data entries in directory database 114 and determines if the data request from the client is consistent with the permitted scope of data access associated with the user account. In an embodiment, the permitted scope of data access includes types of tables and types of data that the client may access in application database 118.

If directory service 112 determines that the client does not have specific data permission to access the requested data (decision block 225, no branch), then directory service 112 sends an authentication failure response (step 230). In other words, directory service 112 supersedes any message content received from data state service 116 and sends a response to the client indicating that the request can not be authenticated, and directory service 112 terminates the response. For example, directory service 112 may send a response message indicating that the user account is not permitted to access the requested data.

If directory service 112 determines that the client has specific data permission to access the requested data (decision block 215, yes branch), directory service 112 permits the client access to the requested data in application database 118.

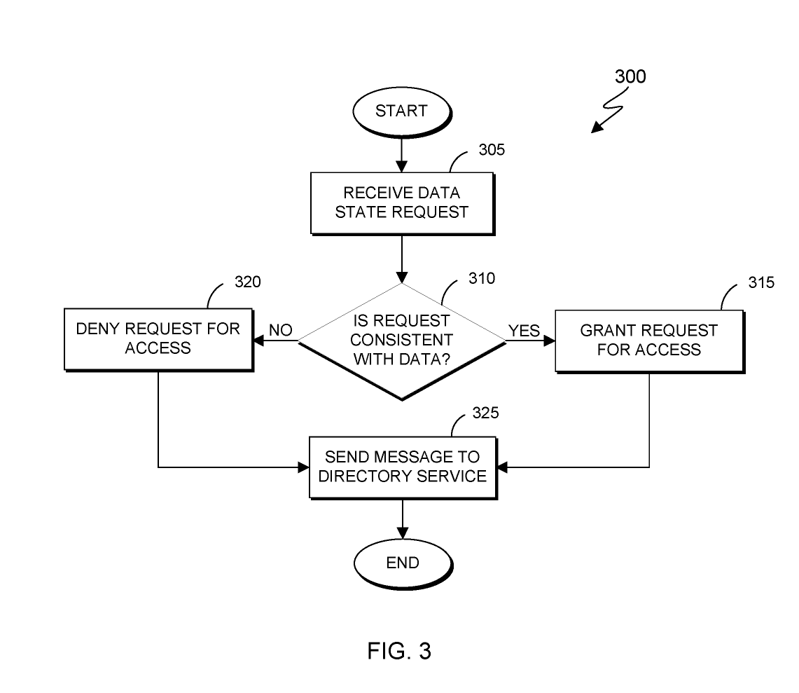

FIG. 3 is a workflow of operational steps of one example of a method for providing data consistency in a data processing environment. In the illustrated embodiment, the steps of workflow 300 are performed by data state service 116. In an alternative embodiment, the steps of workflow may be performed by any other computer program, or programs, while working with data state service 116. In an embodiment, data state service 116 begins performing the steps of workflow 300 in response to receiving an indication to begin providing data consistency in a virtual data processing environment. For example, a user, through the user interface of data state service 116, may provide the indication.

Data state service 116 receives a data state request (step 305). In other words, data state service 116 receives a request from directory service 112 for the state of the data requested by computing device 120 to be accessed. In an embodiment, data state service 116 receives the initial data request from computing device 120, or the client. In an embodiment, data state service determines a date or time (e.g., a timestamp) of the data request at the time data state service 116 receives the request from the client.

Data state service 116 determines if the request is consistent with the data (decision block 310). In other words, data state service 116 determines if the scope of the requested data is consistent with the scope of the data stored in application database 118. In an embodiment, data state service 116 determines consistency with respect to the date or time of the data and the range of the data (e.g., the tables and columns containing the data) for the request and the stored data. In an embodiment, the data request is not consistent with the stored data if the requested range of data is not updated or not available in application database 118 at the time of the request.

Responsive to determining that the request is consistent with the data (i.e., the requested data is available) (decision block 310, yes branch), data state service 116 creates a message content that permits directory service 112 to allow the client to access the requested data (step 315). Responsive to determining that the request is not consistent with the data (i.e., the requested data is not available) (decision block 310, no branch), data state service 116 creates a message content that denies the request from the client for access to the requested data (step 320).

Data state service 116 sends the message in return to directory service 112 (step 325). In other words, data state service 116 sends a message in return to directory service 112 with message content based on the determination in step 315 or step 320.

FIG. 4 depicts computing system 400, which illustrates one embodiment of components of server device 110 and computing device 120. Computing system 400 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 may be implemented with one or more buses or a crossbar switch.

Memory 402 and persistent storage 405 are computer readable storage media. In an embodiment, memory 402 includes random access memory (RAM) (not shown). In general, memory 402 may include any suitable volatile or non-volatile computer readable storage media. Cache 403 is a fast memory that enhances the performance of processor(s) 401 by holding recently accessed data, and data near recently accessed data, from memory 402.

Program instructions and data used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data used to practice embodiments of the present invention may be downloaded to persistent storage 405 through communications unit 407.

I/O interface(s) 406 allows for input and output of data with other devices that may be connected to each computer system. For example, I/O interface 406 may provide a connection to external devices 408 such as a keyboard, keypad, a touch screen, and/or some other suitable input device. External devices 408 can also include portable computer readable storage media such as, for example, thumb drives, portable optical or magnetic disks, and memory cards. Software and data used to practice embodiments of the present invention can be stored on such portable computer readable storage media and can be loaded onto persistent storage 405 through I/O interface(s) 406. I/O interface(s) 406 also connect to display 409.

Display 409 provides a mechanism to display data to a user and may be, for example, a computer monitor.

The descriptions of the various embodiments of the present invention have been presented for purposes of illustration, but are not intended to be exhaustive or limited to the embodiments disclosed. Modifications and variations of the presented embodiments will be apparent to those of ordinary skill in the art without departing from the scope and spirit of the invention. The terminology used herein was chosen to best explain the principles of the embodiment, to best explain the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for providing data consistency in a data processing environment, the method comprising:
receiving a request for data in a database from a client;
determining that the client has permission to access the database previous to accessing the data state service, wherein determining that the client has permission to access the database comprises accessing directory service entry information;
determining that the client has permission to access a data type and a table type of the data previous to accessing the data state service;
determining that a data state service is available previous to accessing the data state service;
accessing the data state service to determine availability of the data; and
responsive to determining, via the data state service, that the data is available, permitting the client to access the data; and
responsive to determining, via the data state service, that the data is not available, terminating the request.
